(19) United States
(12) Patent Application Publication
(10) Pub. No.: US 2025/0355138 A1
(43) Pub. Date: Nov. 20, 2025

(54) LENS WITH LAYERED EXTENSION PORTION

(71) Applicant: Samsung Electro-Mechanics Co., Ltd., Suwon-si (KR)

(72) Inventors: Sung Jin PARK, Suwon-si (KR); Jin Woo YI, Suwon-si (KR); Jai Dong LIM, Suwon-si (KR); Young Jin HWANG, Suwon-si (KR); Young Kyo JUNG, Suwon-si (KR)

(73) Assignee: Samsung Electro-Mechanics Co., Ltd., Suwon-si (KR)

(21) Appl. No.: 19/025,553

(22) Filed: Jan. 16, 2025

(30) Foreign Application Priority Data
May 14, 2024 (KR) 10-2024-0063310

(51) Int. Cl. G02B 1/11

(52) U.S. Cl. CPC G02B 1/11

(57) ABSTRACT

A lens with a layered extension portion is provided. The lens includes a substrate; a first coating film disposed on the substrate, and including a split layer that divides the first coating film into two layers; and a second coating film disposed on the first coating film and having a nano-porous structure (NPS).

### CROSS-REFERENCE TO RELATED APPLICATIONS

This application claims the benefit under 35 USC § 119(a) of Korean Patent Application No. 10-2024-0063310 filed on May 14, 2024, in the Korean Intellectual Property Office, the entire disclosure of which is incorporated herein by reference for all purposes.

### BACKGROUND

### 1. Field

The following description relates to a lens.

### 2. Description of Related Art

In order to reduce a flare phenomenon occurring in multiple lenses, the typical low-reflection lenses with a reflectance of less than about 0.5% may be manufactured by repeatedly depositing high-refractive-index thin films and low-refractive-index thin films.

Moreover, for ultra-low reflection lenses with a reflectance lowered to approximately 0.15% or less, a nano-porous structure (NPS) may be applied to further reduce the flare phenomenon.

The typical anti-reflective coating lens to which NPS is applied may have a structure of a lens portion, a silicon dioxide (SiO₂) layer, and an aluminum oxide (Al₂O₃) layer, or a structure of a lens portion, an interlayer, a SiO₂ layer, and an Al₂O₃ layer, and each of the layers may be manufactured by depositing a thin film with a thickness of several nm to several tens of nm and then immersing the deposited thin film in distilled water at 50° C. to 100° C. for 5 minutes or more (hot water treatment (HWT) process) to convert the uppermost Al₂O₃ layer into a nanostructure.

Additionally, in order to verify reliability of the manufactured lens, a test may be conducted to withstand thermal shock under an environment having a temperature of approximately 100° C. However, cracks may occur due to stress between the thin films during the HWT process or the reliability evaluation, and then these cracks may lead to an increase in the defect rate of products.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens includes a substrate; a first coating film disposed on the substrate, and comprising a split layer that divides the first coating film into two layers; and a second coating film disposed on the first coating film and having a nano porous structure (NPS).

The second coating film may have a graded index in which a refractive index increases from an upper end of the second coating film to a lower end of the second coating film.

The lens may further include an interlayer disposed between the substrate and the first coating film.

The first coating film may include a first expansion layer disposed at an upper side of the first coating film, and a second expansion layer disposed at a lower side of the first coating film, and the first expansion layer and the second expansion layer may be separated by the split layer.

The split layer may be formed to be thinner than the first expansion layer.

A thickness of the first expansion layer may be different from a thickness of the second expansion layer.

A thickness of the first expansion layer may be thinner than a thickness of the second expansion layer.

The split layer may have a higher refractive index than a refractive index of the first expansion layer and a refractive index of the second expansion layer.

The second coating film may have a higher refractive index than a refractive index of the first expansion layer and a refractive index of the second expansion layer.

The first expansion layer and the second expansion layer may each include at least one of silicon dioxide (SiO₂), Si-based mixed oxide or nitride, and magnesium fluoride (MgF₂).

The split layer may include aluminum oxide (Al₂O₃).

The second coating film may include aluminum oxide (Al₂O₃).

In a general aspect, a lens includes a substrate; an interlayer disposed on an upper surface of the substrate; a first coating film disposed on the interlayer, and comprising a first expansion layer, a second expansion layer, and a split layer that separates the first expansion layer and the second expansion layer; and a second coating film disposed on the first coating film and having a nano porous structure (NPS).

A thickness of the first expansion layer may be thinner than a thickness of the second expansion layer.

Other features and aspects will be apparent from the following detailed description, the drawings, and the claims.

### BRIEF DESCRIPTION OF DRAWINGS

FIG. 1 is a cross-sectional view schematically illustrating a stack structure of an example lens, in accordance with one or more embodiments.

FIG. 2 is a cross-sectional view schematically illustrating a stack structure of an example lens, in accordance with one or more embodiments.

FIG. 3 is a cross-sectional view schematically illustrating a stack structure of a typical lens (Comparative Example 1).

FIG. 4 is a cross-sectional view schematically illustrating a stack structure of a typical lens (Comparative Example 2).

FIG. 5 is a graph comparing a reflectance of Comparative Example 1, a reflectance of Comparative Example 2, and a reflectance of an Example embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The one or more examples may provide a lens in which a split layer is disposed such that a first coating film that expands an anti-reflection bandwidth is divided into two layers, in a low-reflection lens to which a nano-porous structure (NPS) is applied, thereby reducing reflectance and an occurrence rate of crack.

One or more examples may provide a lens that reduces an occurrence rate of cracks while improving an anti-reflection effect.

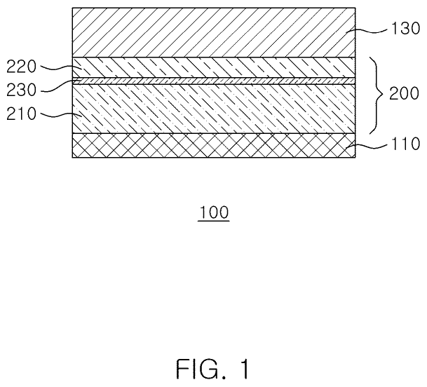

FIG. 1 is a cross-sectional view schematically illustrating a stack structure of an example lens, in accordance with one or more embodiments.

Referring to FIG. 1, a lens 100, in accordance with one or more embodiments, may include a substrate 110, a first coating film 200, and a second coating film 130.

A shape or a type of the substrate 110 may be not particularly limited, and the substrate 110 may be implemented in a lens that may be used in an optical device such as, but not limited to, a camera module or the like.

In a non-limited example, the substrate 110 may be formed of a material such as a polymer or the like, and may be formed of, for example, a plastic resin or the like including a resin component.

The first coating film 200 may be disposed on an upper side of the substrate 110 in order to lower reflectance of a surface of the substrate 110, and may act as (or be) an extension portion to further widen an anti-reflection bandwidth, thereby reducing or preventing a flare phenomenon.

The first coating film 200 may have a split layer 230 disposed in an intermediate portion in a vertical direction such that the extension portion may be divided into two layers as upper and lower layers.

In this example, a layer disposed above the split layer 230 may be referred to as a first expansion layer 220, and a layer disposed below the split layer 230 may be referred to as a second expansion layer 210.

When the first coating film 200 is divided into the first expansion layer 220 and the second expansion layer 210 in this manner, the stress due to the difference in thickness between the thin films may be reduced, thereby reducing an occurrence rate of crack.

In this example, the respective first and second expansion layers 220 and 210 may include at least one of SiO2, Si-based mixed oxide or nitride, magnesium fluoride (MgF₂), or the like.

The Si-based mixed oxides or nitrides may be SiNX, SiAlXOy, SiAlXOyNz, or the like.

Additionally, in an example, the respective first and the second expansion layers 220 and 210 may have different thicknesses, and, in a non-limited example, a thickness of the first expansion layer 220 may be formed to be thinner than a thickness of the second expansion layer 210.

The split layer 230 may be formed of a material having a higher refractive index than a main material included in the respective first and second expansion layers 220 and 210.

In an example, when the respective first and second expansion layers 220 and 210 include SiO₂, the split layer (230) may include Al₂O₃ having a higher refractive index than SiO₂.

When the split layer 230, which may have a relatively higher refractive index than the respective first and second expansion layers 220 and 210 is disposed between the first expansion layer 220 and the second expansion layer 210, graded index and high-refractive index/low-refractive index anti-reflection effects may be combined, such that a more reflectance-reducing effect may be expected, as compared to a coating film to which only the graded index is applied.

In this example, the split layer 230 may be formed to be thinner than the first expansion layer 220. A main role of the split layer 230 may be to reduce or to prevent stress from occurring in an adjacent layer due to the excessive thickness of the first coating film 200, and when the split layer 230 is thicker than the first expansion layer 220, problems such as a reduction in mass productivity due to a delay in deposition time and a reduction in anti-reflection effect may occur.

The second coating film 130 may be disposed at an upper side of the first coating film 200, and in an example, may be disposed at an upper side of the first expansion layer 220.

In an example, the second coating film 130 may be formed as a nano-porous structure (NPS).

The second coating film 130 may have a graded index in which a refractive index of a portion that contacts air is close to 1 and the refractive index gradually increases toward the first coating film 200 at the lower side.

The second coating film 130 may have an anti-reflective effect to further lower reflectance of the lens 100.

The second coating film 130 may be formed of a material that has a higher refractive index than the respective first and second expansion layers 220 and 210.

In an example, when the respective first and second expansion layers 220 and 210 include SiO₂, the second coating film 130 may include Al₂O₃ having a higher refractive index than SiO₂.

When the first coating film 200 is formed too thickly on the lens, stress with the substrate may increase, which may increase the occurrence of cracks.

In an example, the first coating film 200 may be divided into a first expansion layer 220 and a second expansion layer 210, having thin thicknesses, to reduce stress between the thin films, and thus reduce an occurrence rate of cracks.

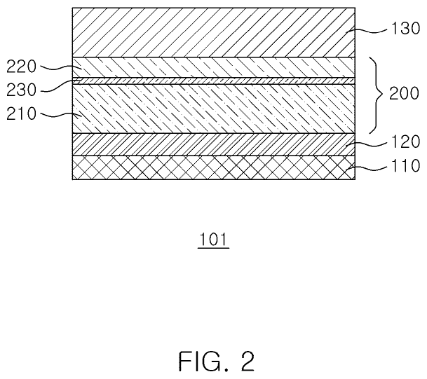

Referring to FIG. 2, an example lens 101, in accordance with one or more embodiments, may further include an interlayer 120 disposed between a substrate 110 and a first coating film 200.

The interlayer 120 may be a bonding layer that bonds the substrate 110 and the first coating film 200, and may play a role in eliminating a delamination phenomenon between the substrate 110 and the first coating film 200.

In this example, the interlayer 120 may be formed to be thinner than the first coating film 200. Since the interlayer 120 is intended to prevent a delamination phenomenon that may occur when adhesive strength between the substrate 110 and the first coating film 200 is low, the interlayer 120 may be formed with a minimum thickness at a level where a delamination phenomenon does not occur.

Additionally, in an example, the interlayer 120 may be formed to be thicker than a first expansion layer 220, and may be formed to be thinner than a second expansion layer 210.

Additionally, in an example, the interlayer 120 may be formed to be thinner than a second coating film 130.

Typically, when an interlayer is disposed between a substrate and a first coating film, reflectance may increase somewhat while an occurrence rate of cracks may also increase.

In accordance with an embodiment, a split layer 230 may be applied to divide a first coating film 200 into respective first and second expansion layers 220 and 210, to realize a low-reflection coating structure simultaneously implementing NPS and high-refractive index/low-refractive index anti-reflection effects, while the first coating film 200, which was formed to be excessively thick, as compared to an interlayer in a typical thin film structure, may be divided into the respective first and second expansion layers 220 and 210 with thin thickness, to reduce stress between the thin films and thus reduce an occurrence rate of crack.

### Experimental Example

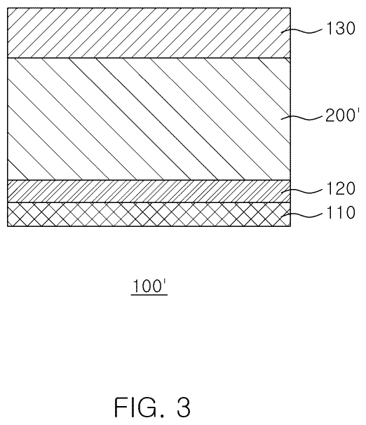

FIG. 3 illustrates Comparative Example 1, and a lens 100′ illustrated in FIG. 3 is a lens which has a typical ultra-low reflection NPS coating structure, and has a structure in which an interlayer 120 is disposed on a substrate 110, a first coating film 200′ as a single layer is disposed on the interlayer 120, and a second coating film 130 is disposed on the first coating film 200′.

The substrate 110 is formed as a polymer lens, the interlayer 120 includes Al₂O₃, and the first coating film 200′ contains SiO₂ and has a thickness about 5 times a thickness of the interlayer 120. The second coating film 130 has NPS and includes Al₂O₃.

In Comparative Example 1, the interlayer 120 has a thickness of 18.4 nm, the first coating film 200′ has a thickness of 101.9 nm, and the second coating film 120 has a thickness of 41.3 nm.

These thicknesses may be measured using a non-destructive test and a destructive test. Examples of the non-destructive test may include ellipsometry, reflectometry, a process using an atomic force microscopes, or the like.

As an example of destructive analysis, each layer, such as the interlayer 120, the first coating film 200′, and the second coating film 130, may be subjected to focused ion beam (FIB) cross-section processing and then transmission electron microscope (TEM) analysis, and components may also be analyzed through EDS analysis. Additionally, the analysis may be performed using FT-IR, XPS, or the like.

A cross-section of each of the layers may be taken to include a central portion of the lens, i.e. the thickest region of the lens.

A thickness of each of the layers may be defined as the distance measured in a direction, perpendicular to a surface thereof, and may be determined as an average value of values measured in a number of equally spaced regions.

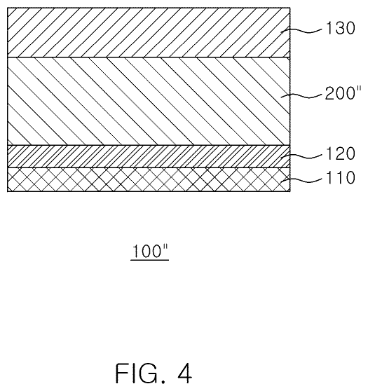

FIG. 4 illustrates Comparative Example 2, and a lens 100″ illustrated in FIG. 4 has a structure in which an interlayer 120 is disposed on a substrate 110, a first coating film 200″ is disposed on the interlayer 120, and a second coating film 130 is disposed on the first coating film 200″.

The substrate 110 is formed as a polymer lens, the interlayer 120 includes Al₂O₃, and the first coating film 200″ includes SiO₂ and has a thickness about 4 times a thickness of the interlayer 120. The second coating film 130 has NPS and includes Al₂O₃.

In Comparative Example 2, the interlayer 120 has a thickness of 18.4 nm, in the same manner as Comparative Example 1, the first coating film 200″ has a thickness of 73.1 nm, and the second coating film 130 has a thickness of 41.3 nm, in the same manner as Comparative Example 1.

That is, Comparative Example 2 has a similar structure to Comparative Example 1, but is characterized in that the thickness of the first coating film is formed to be thinner than that of Comparative Example 1 to improve a defect rate due to occurrence of cracks.

FIG. 2 illustrates the Example embodiment, a lens 101 illustrated in FIG. 2 has a structure in which an interlayer 120 is disposed on a substrate 110, a first coating film 200 is disposed on the interlayer 120, a second coating film 130 is disposed on the first coating film 200, and the first coating film 200 is divided into a second expansion layer 210 disposed at a lower side of a split layer 230 and a first expansion layer 220 disposed at an upper side of the split layer 230, by the split layer 230.

The substrate 110 is formed as a polymer lens, the interlayer 120 contains Al₂O₃, the respective first and second expansion layers 220 and 210 of the first coating film 200 included SiO₂, and the second coating film 130 may include NPS and Al₂O₃.

In the Example embodiment, the interlayer 120 may have a thickness of 18.4 nm, in the same manner as Comparative Examples 1 and 2, and the second coating film 130 may have a thickness of 41.3 nm, in the same manner as Comparative Examples 1 and 2.

The first expansion layer 220 may have a thickness of 16.7 nm, the second expansion layer 210 may have a thickness of 40.8 nm, and the split layer 230 may have a thickness of 5.7 nm.

Hereinafter, high-temperature reliability evaluation was performed for 2 hours at 120° C. conditions using the lenses of Comparative Example 1, Comparative Example 2, and the Example embodiment, and the number of cracks and the crack occurrence rates before and after the evaluation were measured, which are illustrated in Table 1 below.

TABLE 1

| | Before High-Temperature | | After High-Temperature | |
|---|---|---|---|---|
| | Reliability Evaluation | | Reliability Evaluation | |
| | Number of | Crack | Number of | Crack |
| | Defective | occurrence | Defective | Occurrence |
| | (EA) | Rate (%) | (EA) | Rate (%) |
| Comparative | 173/432 | 40.0 | 432/432 | 100.0 |
| Example 1 | | | | |
| Comparative | 66/432 | 15.3 | 432/432 | 100.0 |
| Example 2 | | | | |
| Example | 33/432 | 7.6 | 33/432 | 7.6 |
| Embodiment | | | | |

As illustrated in Table 1, in Comparative Example 1, cracks occurred in 173 out of a total 432 products before the high-temperature reliability evaluation, illustrating a crack occurrence rate of 40.0%, and cracks occurred in all products after the high-temperature reliability evaluation.

In Comparative Example 2, in which the thickness of the first coating film was relatively thinner than that of Comparative Example 1, cracks occurred in 66 out of a total of 432 products before the high-temperature reliability evaluation, which reduced to have a crack occurrence rate of 15.3%, as compared to Comparative Example 1. However, after the high-temperature reliability evaluation, cracks occurred in all products, the same as in Comparative Example 1.

Moreover, as in Comparative Example 2, when the thickness of the first coating film was reduced, reflectance also slightly increases.

That is, it may be seen that simply reducing the thickness of the first coating film may not improve the crack occurrence rate after high-temperature reliability, and rather, a problem of increasing reflectance occurred further.

In the Example embodiment, the split layer 230 was inserted in an intermediate portion of the first coating film 200, to divide the first coating film 200 into the first expansion layer 220 and the second expansion layer 210, such that the thicknesses of the first expansion layer 220, the split layer 230, and the second expansion layer 210 excluding the second coating film 130, were significantly reduced, as compared to Comparative Example 1, to reduce stress between thin films.

In particular, the thickness of the second expansion layer 210 adjacent to the interlayer 120 was 40.8 nm, which may be significantly reduced to about half the thickness of Comparative Example 2.

Accordingly, not only the crack occurrence rate before the high-temperature reliability evaluation significantly reduced to 7.6% as compared to Comparative Examples 1 and 2, but also the crack occurrence rate after the high-temperature reliability evaluation did not increase to 7.6%, the same as before the reliability evaluation, indicating that it was also effective in preventing occurrence of crack due to thermal shock.

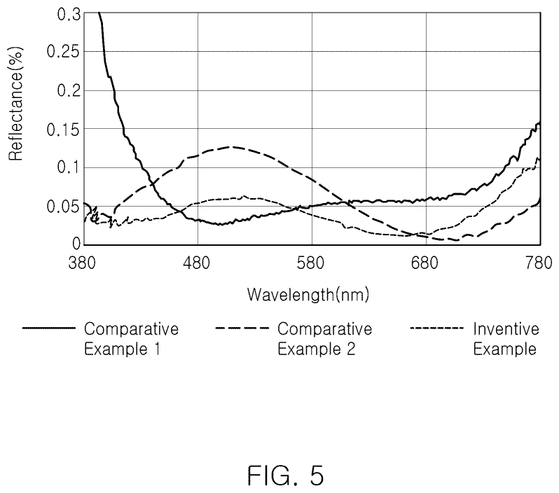

FIG. 5 is a graph comparing a reflectance of Comparative Example 1, a reflectance of Comparative Example 2, and a reflectance of the Example embodiment.

Referring to FIG. 5, an average reflectance of Comparative Example 1 was 0.08%, an average reflectance of Comparative Example 2 was 0.06%, and an average reflectance of the Example embodiment was 0.04%, confirming that the reflectance of the Example embodiment was the lowest. The reflectance was an average of the reflectance in a range of 380 nm to 780 nm.

Additionally, in accordance with one or more embodiments, an overall thickness of a portion deposited on a lens may be reduced. As a criterion before the high-temperature reliability evaluation, a total thickness deposited in Comparative Example 1 was 161.6 nm, a total thickness deposited in Comparative Example 2 was 132.8 nm, and a total thickness deposited in the Example embodiment was 122.9 nm, which was reduced compared to Comparative Examples 1 and 2. Therefore, a cost reduction effect may be expected in the Example embodiment, as compared to the typical lens.

In this example, each layer may be formed by deposition using an atomic layer deposition (ALD) process, and if a total deposition time of Comparative Example 1 is 100%, 90% is required in Comparative Example 2 and 80% is required in the Example embodiment, such that according to an embodiment, a manufacturing time period may be shortened and manufacturing costs may be further reduced, as compared to the typical structure.

According to the one or more examples, an effect of reducing a reflectance of a lens and an occurrence rate of cracks may be achieved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens, comprising:
a substrate;
a first coating film disposed on the substrate, and comprising a split layer that divides the first coating film into two layers; and
a second coating film disposed on the first coating film and having a nano porous structure (NPS).

2. The lens according to claim 1, wherein the second coating film has a graded index in which a refractive index increases from an upper end of the second coating film to a lower end of the second coating film.

3. The lens according to claim 1, further comprising an interlayer disposed between the substrate and the first coating film.

4. The lens according to claim 1, wherein the first coating film comprises a first expansion layer disposed at an upper side of the first coating film, and a second expansion layer disposed at a lower side of the first coating film, and
wherein the first expansion layer and the second expansion layer are separated by the split layer.

5. The lens according to claim 4, wherein the split layer is thinner than the first expansion layer.

6. The lens according to claim 4, wherein a thickness of the first expansion layer is different from a thickness of the second expansion layer.

7. The lens according to claim 4, wherein a thickness of the first expansion layer is thinner than a thickness of the second expansion layer.

8. The lens according to claim 4, wherein the split layer has a higher refractive index than a refractive index of the first expansion layer and a refractive index of the second expansion layer.

9. The lens according to claim 4, wherein the second coating film has a higher refractive index than a refractive index of the first expansion layer and a refractive index of the second expansion layer.

10. The lens according to claim 4, wherein the first expansion layer and the second expansion layer each comprise at least one of silicon dioxide (SiO₂), Si-based mixed oxide or nitride, or magnesium fluoride (MgF₂).

11. The lens according to claim 10, wherein the split layer comprises aluminum oxide (Al₂O₃).

12. The lens according to claim 10, wherein the second coating film comprises aluminum oxide (Al₂O₃).

13. A lens, comprising:
a substrate;
an interlayer disposed on an upper surface of the substrate;
a first coating film disposed on the interlayer, and comprising a first expansion layer, a second expansion layer, and a split layer that separates the first expansion layer and the second expansion layer; and
a second coating film disposed on the first coating film and having a nano porous structure (NPS).

14. The lens of claim 13, wherein a thickness of the first expansion layer is thinner than a thickness of the second expansion layer.
